(19) United States
(12) Patent Application Publication
(10) Pub. No.: US 2005/0015816 A1
(43) Pub. Date: Jan. 20, 2005

(54) System and method of providing triggered event commands via digital program insertion splicing

(75) Inventors: Michael G. Christofalo, Doylestown, PA (US); Stephen Riedl, Superior, CO (US)

Correspondence Address: OPTV/MOFO;C/O MORRISON & FOERSTER LLP, 1650 TYSONS BOULEVARD, SUITE 300, MCLEAN, VA, 22102, US

(73) Assignees: ACTV, Inc, New York, NY (US); nCUBE, Beaverton, OR (US)

(21) Appl. No.: 10/695,663

(22) Filed: Oct. 29, 2003

Related U.S. Application Data
(60) Provisional application No. 60/422,245, filed on Oct. 29, 2002.

(51) Int. Cl. H04N 7/16; H04N 7/10; H04N 7/025; H04N 7/00

(52) U.S. Cl. 725/136; 348/460; 348/461; 715/500.1; 725/34; 725/35; 725/138

(57) ABSTRACT

Systems and methods for the insertion of commands and/or other data into a digital programming stream are described. These command and/or data may be inserted into digital advertisement or other programs and may utilized by any device which is involved in the generation, transmission, reception and/or presentation of content via a digital programming stream.

### INVENTIVE FIELD

The inventive field relates to the providing of in-band commands via a digital advertisement or other content insertion and programming system. More specifically, the inventive field relates to systems and methods for synchronizing data and advertisements in a digital advertising insertion system.

### BACKGROUND

Traditionally broadcast, cable and other providers of television, radio and other forms of audio, video and other programming signals have communicated programs (such as a sit-com or news broadcast) and advertisements in an analog format. For most of the history of radio and television, analog signals have adequately met programmers and advertisers needs. However, in the 1980-1990s a paradigm shift occurred, in part due to a change in the regulatory structure of broadcasting and the development of new technologies. Basically, this paradigm shift resulted in viewers or listeners (e.g., of radio programs), hereinafter, collectively “viewers”, desiring to receive and have access to an ever larger number of television and radio programs. Instead of having access to the three then major television networks (i.e., ABC®, CBS®, and NBC®), viewers suddenly were being provided access to an ever larger number of programs at the same time. This paradigm shift resulted in the number of channels available for viewing, at any given time, increasing significantly to often greater than the 150 channels available today.

As viewer's demands and willingness to pay for an ever greater number of channels and/or programming signals increased, programmers initially satisfied such demand by providing multi-channel analog cable systems and similar analog systems. These analog systems generally are capable of providing approximately 50 channels/programming signals at any given time. However, while 50 channels were a large number compared to only three or so, viewer's, producers, and/or transmitters (e.g., cable system operators) desired to provide an ever greater number of channels at any given time. However, since analog signals were still the primary communication format, bandwidth constraints limited the deployment of cable and other systems offering a greater number of channels.

Yet, the demand for more channels did not subside. So, in the early 1990s, programmers agreed to a standard for sampling and compressing analog signals into a digital format. Digital encoding of program signals effectively enabled cable operators and others to significantly increase the number of programming signals available to a viewer at any given time. To ensure all systems could process digital signals, various standards were promulgated by the Moving Pictures Experts Group (“MPEG”) and others. MPEG and other standards have since been widely adopted as the standards for transmitting digitally encoded video and audio signals.

More specifically, various MPEG standards provide for the compression and transmission of full-motion video with accompanying audio over virtually any digital communications medium including cable systems, satellite systems, broadcast, networked systems, such as the Internet (for example by streaming of audio and video), and other communication mediums. Further, the various MPEG standards enable transmitters to provide an ever-increasing number of programming signals simultaneously to a viewer's television or other reception/presentation device. These advances have provided programmers as well as advertisers with more options for providing unique, customized or other programming. Further, as the number of programming options have increased so to have options for inserting advertisements in such programming signals. For example, MPEG compression standards have resulted in an explosion of available “channels” available within the same bandwidth over cable and direct broadcast satellite (DBS) systems. This ever greater number of available channels/programming signals effectively enables advertisers to target advertisements at viewers of particular programming or types of programming.

The first MPEG standard, labeled MPEG-1, is intended primarily for the encoding of video for storage on digital media such as a CD-ROM. It provides for video processing at a resolution of 352×240 pixels which is known as Source Input Format (SIF). The SIF resolution is only about one quarter of the resolution of the broadcast television standard (CCIR 601) which calls for 720×480 pixels. The MPEG-1 standard provides for bit rates for encoding and decoding full-motion video data of about 1.5 mega-bits-per-second (“Mbps”).

However, MPEG-1 has no provisions for transporting compressed audio/video over a high speed one way real-time network such as cable or satellite. Further, resolution and bit rate provided by MPEG-1 is inadequate for high quality presentation of full-motion video by the broadcast and subscription television industries. Therefore, a second standard, MPEG-2, has been developed.

MPEG-2 provides an enhanced compression scheme to allow transmission of full-motion video at broadcast studio quality, 720×480 pixel resolution. A much higher data encode and decode rate of 6 Mbps is required by the MPEG-2 standard. Many Multi System Operators (“MSOs”) compress video at higher than 6 Mbps. For example, the AT&T® HITS system, which uses variable bit rate encoding and statistical multiplexing produces twelve channels of video with an average bit rate of approximately 1.7 Mbps. MPEG-2 is commonly used by the cable television and direct broadcast satellite industries because it provides increased image quality, support of interlaced video formats, and scalability between multiple resolutions.

A standard MPEG video stream contains different types of encoded frames comprising the full-motion video. There are I-frames (intra-coded), P-frames (predicated), and B-frames (bi-directionally predicated). A standard MPEG structure is known as a “group of pictures” (“GOP”). GOPs usually start with an I-frame and can end with either P- or B-frames. An I-frame consists of the initial, detailed picture information to recreate a video frame. The P- and B- frames consist of instructions for changes to the picture constructed from the I-frame. P-frames may include vectors which point to the I-frame, other P- or B-frames within the GOP, or a combination, to indicate changes to the picture for that frame. B-frames may similarly point to the I-frame, other P- or B- frames within the same GOP, frames from other GOPs, or a combination. The vector pointers are part of the MPEG scheme used to reduce duplication in the transmitted data, thereby resulting in the compression effects. MPEG is a packet-based scheme, so each GOP is further broken up into uniformly sized data packets for transmission in the transport stream. Each packet includes a Packet Identifier (“PID”) which provides a 13-bit value that is used to identify the type of data stored in the packet payload. MPEG packets may include video, audio, or other information (such as data or commands). For additional information, the MPEG coding standard can be found in the following documents: ITU-T Rec: H.222.0/ISO/IEC 13818-1 (1996-04), Information Technology-Generic Coding of Moving Pictures and Associated Audio Information: Systems; and ITU-T Rec: H.222.0/ISO/IEC 13818-2 (1996-04), Information Technology-Generic Coding of Moving Pictures and Associated Audio Information: Video.

The two major requirements of MPEG compression are: (1) that the frame rate for a full-motion video presentation be 30 frames-per-second, and (2) that any accompanying audio be reconstructed in true CD-quality sound. At the MPEG-2 main level, main profile (MLMP) picture resolution of 704×480 pixels the size of a typical I-frame is about 256 Kb. Related B-frames and P-frames are substantially smaller in size as they merely contain changes from the related I-frame and/or each other. On average, one second of broadcast resolution video (i.e., 30 frames-per-second), compressed according to MPEG-2 standards, is about 2 Mb. In comparison, an I-frame in SIF resolution is approximately one quarter the size of a comparable MLMP I-frame, or about 64 Kb. CD-quality audio is defined as a 16 bit stereo sound sampled at a rate of 44.1 KHz. Before compression, this translates to a data rate of 1.411 Mbps. MPEG-2 compression provides for an audio data rate of up to about 256 Kbps. Other audio standards may be substituted for MPEG-2. For example, in the United States (“U.S.”), the Advanced Television System Committee of America's (“ATSC”) chosen audio standard is Dolby® Digital. Most cable broadcasters in the U.S. use Dolby® Digital, not MPEG audio. Over the next several years as digital television terrestrial broadcasting begins, Dolby® Digital will likewise be used in those broadcasts.

Beyond the expanded programming now available, the additional bandwidth created through digital compression and transmission technologies has provided the opportunity to transmit multiple, synchronized transport streams within the bandwidth of a single 6 MHz National Television Standards Committee (NTSC) channel. U.S. Pat. Nos. 5,155,591 and 5,231,494 discuss in detail the provision of targeted advertising by either switching between separate commercials, or between related, interchangeable advertising segments, transmitted over multiple programming streams multiplexed within the same channel bandwidth.

In general, the adoption of MPEG-2 resolved one of the primary difficulties in providing an increased variety in the quantity of programs and content available to a given viewer. In short, MPEG effectively increased the size of the pipe via which content was being provided to a user. As this pipe has increased, so has the desire of advertisers increased to provide ever greater targeting of advertisements, programming and other content to viewers. Further, since the adoption of the MPEG standards numerous digital transmission mediums have come into widespread use for transmitting programming digitally to viewer's reception systems, these transmission mediums have included satellite systems (for example, News Corps®. SKY® television providing satellite television services in the U.K., DISH Network® and DirectTV® and others) and digital cable systems. In general, each of these transmission systems were quick to adopt digital transmission mediums, thereby providing an ever larger number of program offerings over a fixed bandwidth.

Currently, when providing an advertisement for insertion into a program to be provided via a digital programming stream, the program and any commercial segments are provided in an analog format. The commercial segments are then inserted into the program and then the entirety of the program and the advertisements are encoded, together into a digital format. As one may appreciate, this method generally does not enable broadcasters, transmitters, cable operators and other very much flexibility in modifying, inserting and/or deleting programs and/or advertisements from a given digital programming stream.

To address this need for a more robust system for inserting advertisements into a digital programming stream, the Society of Cable Telecommunications Engineers (“SCTE”) has adopted various standards for providing advertising in a digital programming stream. Two of these standards are of particular relevance to the present discussion. The first of these standards is SCTE 35 2001 (hereinafter, “DVS253”), which is entitled “Digital Program Insertion Cueing Message for Cable, and was first issued on September 27, 1999, the entire contents of which are incorporated herein by reference. The second SCTE standard is SCTE 30 2001 (hereinafter, “DVS380”), which is entitled “Digital Program Insertion Splicing API”, and was adopted on Jan. 18, 2001, the entire contents of which are incorporated herein by reference.

More specifically, the DVS253 standard specifies a technique for notifying advertisement inserters or splicers when a given digitally encoded program signal has an upcoming insertion point into which digitally encoded advertisements may be inserted. It is to be appreciated that in addition to inserting advertisements into a digital program signal, other digitally encoded data or information (i.e., “content”) may also, or alternatively, be inserted at any splice point into a digital program signal. As such, throughout this specification, a reference to an “advertisement” may also be interpreted to include a reference to other forms of content.

More specifically, an MPEG-2 transport stream commonly includes multiple programming streams and/or a single programming stream. As a given programming signal (e.g., a sit-com) is being communicated over a programming stream (e.g., a given channel on a cable system), upcoming breaks in the programming signal may be communicated to an advertisement insertion system so that a given advertisement (or other content) may be inserted into the programming signal at the appropriate time. In order to notify splicers and other advertisement inserting systems when an insertion point will occur in a given programming signal, the DVS253 standard provides for messages to be encoded into the MPEG-2 transport stream which an advertisement inserter may interpret and based thereon determine when an insertion point will occur. In effect, a DVS253 message is comparable to a “cue tone” which are commonly utilized in analog programming streams and systems.

More specifically, a DVS253 message is provided in a Primary Channel (as defined in the DVS380 standard). As is commonly known in the art, MPEG-2 transport streams are created by multiplexing numerous Primary Channels. By designating In Points (i.e., places in a Primary Channel at which it is acceptable to enter other content, such as and advertisement) and Out Points (i.e., places in a Primary Channel at which it is acceptable to exit the bit stream, i.e., to cease inserting an advertisement into the transport stream), advertisers can be notified when to being inserting an advertisement into a Primary Channel and when to terminate the insertion so that the programming signal may continue. Further, as the programming signal is being transmitted, an Ad Inserter or splicer looks for a DVS253 message packet identified by a unique PID. This message identifies when during the program feed (for example, one from a network) break points will be occurring or cancelled, if necessary. As such DVS253 provides a method for notifying advertisement inserters when an upcoming splice point will occur without requiring the need for special processing since the DVS253 messages are desirably sent in a MPEG-2 transport packet identified by a unique PID.

The other standard of particular relevance to the insertion of digital advertisement into a digital programming stream is DVS380. More specifically, the DVS380 standard provides an Application Program Interface (“API”) which standardizes a method for communication between advertisement servers and/or other content servers and advertisement Inserters/splicers. As shown in FIG. 1, a DVS380 compliant system 100 generally utilizes two components, an advertisement server 102 and an advertisement inserter/splicer 104. The splicer 104 suitably receives from an external source a primary multiplex stream 106 on which a given programming signal is being provided. The splicer 104 also receives from the advertisement server 102, at appropriate times, an insertion multiplex stream 108 on which at least one advertisement or other content may be provided. It is to commonly appreciated that a DVS380 compliant system may also be expanded to include multiple servers and/or multiple splicers, one embodiment of which is shown in FIG. 2.

More specifically, when the splicer 104 receives a “cue-tone” (for example, a DVS253 message) in the primary multiplex stream, the splicer 104 communicates to the server 102 the availability in the primary multiplex stream 106 of splice insertion points. This communication and generally all communications between a splicer 104 and a server 102 is accomplished over a TCP/IP connection, with one connection generally being provided per output multiplex stream 112. The splicer 104 then sends a cue request message, as specified by section 7.4.1. of the DVS380 standard, to the server 102. This message identifies the time of the upcoming splice point and any splice information provided in the DVS253 message. In response to the cue request message, the server 102 acknowledges the upcoming splice and at least three seconds prior to the intended splice time, the server provides a splice request message to the splicer 104. The content of a splice request message is specified in section 7.5.1 of the DVS380 standard. Based upon this message (and/or other messages which may be received from other servers), the splicer 104 inserts the digital data being provided in the insertion multiplex stream 108 into the breaks (or at the splice points) provided in the primary multiplex stream 106 and outputs the combined signal in the output multiplex stream 112. This combined signal contains the programming signal and advertisements appropriately inserted therein. Various other communications additionally may occur between the server 102 and the splicer 104 over the TCP/IP connection 110, as further set forth in the DVS380 standard.

In short, the DVS253 and DVS380 standards provide message formats and API's for providing digitally encoded advertisements into digitally encoded programming signals. With the adoption of the DVS253 and DVS380 standards, programmers are now capable of inserting advertisements directly into digital transport streams instead of encoding both the program and an analog advertisement on a real-time basis. As one may appreciate, these advances have made digital advertisements ever more popular and further increased the demand for ever greater precision in the providing and targeting of advertising to specific viewers and/or groups of viewers.

However, while DVS253 and/or DVS380 systems may be configured to insert advertising and/or other content into a break in a program, current systems still do not provide an efficient mechanism by which instructions and/or other commands may be provided to a viewer's reception system or other components in a digital transmission path. Moreover, DVS380 does not provide a method for the insertion of frame accurate data into an insertion network. More specifically, as the number of transport streams which can be communicated to a viewer at any given time have increased, a need has arisen to also provide commands and other data which instruct viewer reception systems as to which transport stream(s) to present to a given viewer at any time. Advertiser's today generally desire to be able to provide multiple advertisements at the same time, over multiple programming streams and to enable viewer reception systems or other system components to decide which of the plurality of programming streams to present to a viewer in a given break in any programming signal.

Commonly, the providing of commands and other data, in early digital programming systems, was accomplished by directly entering the commands into the encoder as the advertisements were encoded with the programming signal. While such an embodiment was possible, it was not very desirable, because it was not robust, and was not adaptable on a real-time basis.

Further, with the advent of the DVS380 standard, the encoding of the advertisements with the analog program feed is no longer required or accomplished. As such, since the adoption of the DVS380 standard, the encoding of commands and/or other data directly into a programming stream has become impractical if not impossible.

One solution to this dilemma has been to provide the commands in conjunction with any given advertisement packets. In short, for this embodiment, when the splicer 104 inserts an advertisement into a programming signal 106, the advertisement provided on the insertion multiplex stream 102 suitably includes MPEG-2 data packets which contain command and/or other data or instructions.

As one may readily appreciate, this approach has numerous drawbacks. First, it only enables one to insert commands into an advertisement as the advertisement is being inserted into the programming signal and outputted in the output multiplex stream 112. In short, at best, assuming a command could be instantaneously extracted, decoded and implemented by a viewer's receiving device, commands would always be delayed by some small amount of time from their associated advertisement. Second, this approach requires the server 102 to include commands in advertising signals instead of merely obtaining and providing advertising signals directly. In short, this approach requires servers to, in effect, parse commands into advertisements, which may also slow down the processing speed of servers and the communications of advertising packets from the server 102 to the splicer 104.

Thus, a system and method is needed which enables advertisers, programmers and other content providers to provide commands to viewer's reception systems at any time, without requiring such commands and/or other data to be provided as data packets associated with an advertisement and/or encoding directly into the programming signal or an advertising signal in advance to the transmission thereof.

### SUMMARY

The various embodiments of the present invention provides systems and processes for the insertion of frame accurate commands into digital programming signal into which advertisements and/or other content may also be inserted. More specifically, for at least one embodiment of the present invention, commands may be inserted into a digital programming stream by a splicer or similar device. The commands for such an embodiment may be provided to the splicer in a DVS380 message format which provides for the concatenation of descriptors and/or other data fields to such message. One embodiment of a DVS380 message which provides for the attachment of descriptors and/or other data fields is a splice request message.

Further, the various embodiments of the present invention provide systems and processes for receiving commands which are desired to be inserted into a digital programming stream, such as an MPEG-2 transport stream. These systems and processes also provide for the generation of message headers and the addition of the commands to such messages. Such combined header and command messages may also be communicated to at least one device for insertion of such commands into a digital programming signal. In at least one embodiment, such commands are inserted into a digital programming signal by utilizing DVS380 compliant message formats.

Also, the various embodiments of the present invention provide systems and/or methods for receiving messages, extracting and/or parsing commands from such messages and/or determining when to insert such commands into any of a plurality of programming signals. Further, various embodiments of systems and methods may also be provided which enable splicers and/or other devices utilized to insert commands into a digital programming signal or transport stream at specific points in the programming signal, wherein such specific points may be pre-identified in the given programming signal and/or specified in the command and/or based upon a reference time.

Various embodiments of content segments, transmission segments and presentation segments are also provided which may be utilized in conjunction with the various embodiments of the present invention to generate, transmit and implement commands provided in a digital programming signal and/or transport stream.

### BRIEF DESCRIPTION OF THE DRAWING FIGURES

FIG. 1 provides a block diagram representation of one embodiment of a DVS380 compliant system for inserting digital advertising provided by one digital ad server directly into a digital programming stream via a single digital splicer.

FIG. 2 provides a block diagram representation of a second embodiment of a DVS380 compliant system for inserting digital advertising provided by at least one of a plurality of digital ad servers directly into at least one digital programming stream via a plurality of digital splicers.

FIG. 3 is a high-level block diagram representation of a digital programming system which may be utilized with at least one embodiment of the present invention.

FIG. 4 is a block diagram representation of a system which may be utilized by at least one embodiment of the present invention to insert commands into a digital programming stream using DVS380 messages.

FIG. 5 is a representation of one embodiment of a data format which may be utilized in conjunction with at least one embodiment of the present invention to provide commands in DVS380 formatted messages.

FIG. 6 is a more detailed representation of a specific embodiment of a command which has been inserted into a TEC descriptor field attached to a message body in the DVS380 message format.

FIG. 7 is a representation of one embodiment of a timing diagram which may be implemented when two TEC command instructions are provided in a digital programming stream in conjunction with at least one embodiment of the present invention.

FIG. 8 is a flow chart illustrating one method which may be utilized to generate a DVS380 message which contains commands to be inserted into a digital programming stream for at least one embodiment of the present invention.

FIG. 9 is a flow chart illustrating one method by which a DVS380 formatted command message may be received, parsed and inserted into a digital programming stream for at least one embodiment of the present invention.

FIG. 10 is a pictorial representation of one possible implementation of at least one embodiment of the present invention.

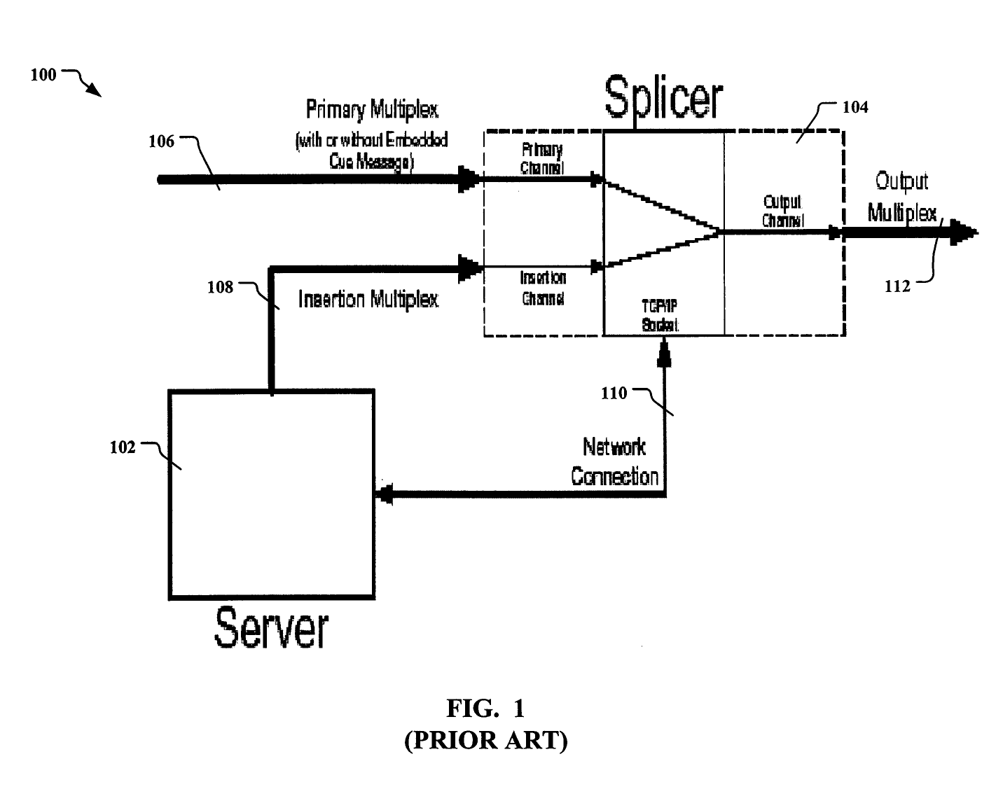

### DETAILED DESCRIPTION

The various system and method embodiments of the present invention provide for the insertion of commands and/or other data into a digital programming stream. These commands and/or data may be inserted into digital advertisements or other programs and may be utilized by any device which is involved in the generation, transmission, reception and/or presentation of content via a digital programming stream. Ideally, these commands may be inserted at any time into an output multiplex stream and are not required to be inserted in advertisement or at specific splice points in a given programming signal.

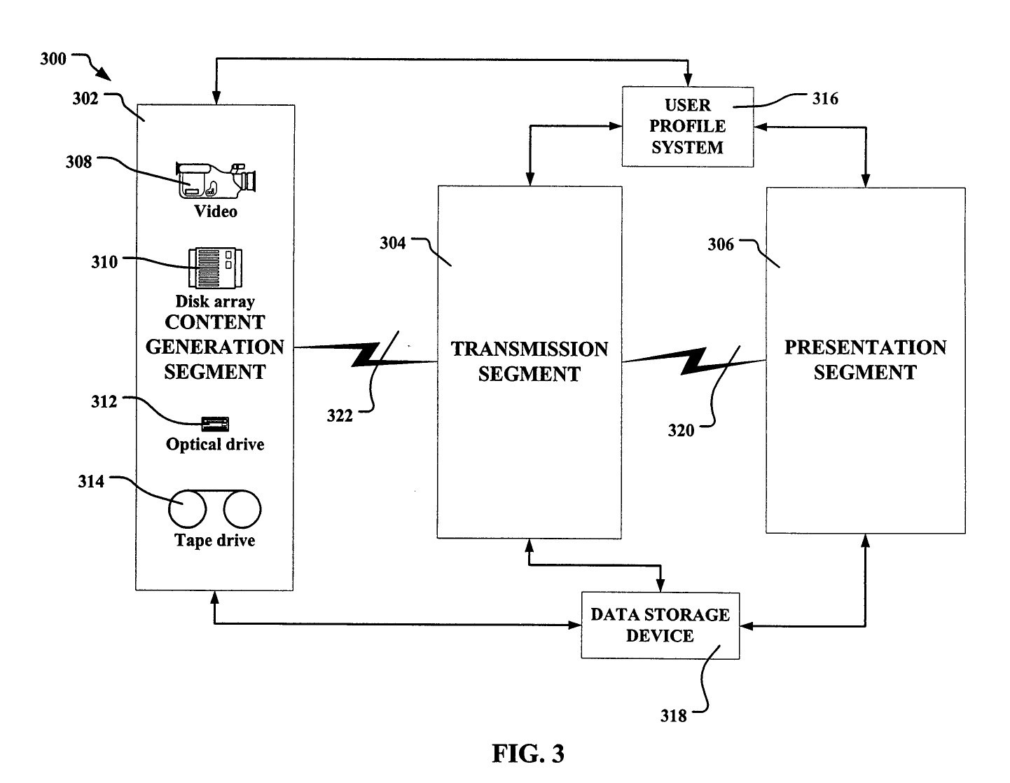

One embodiment of a digital programming system which may be utilized to provide commands and/or data in a digital programming stream, consistent with the teachings herein, is shown in FIG. 3. As shown, an overall digital programming system can generally be broken-out into three basic segments: a content segment 302, a transmission segment 304 and a presentation segment 306. Any of these segments may be configured to utilize commands and/or other data provided in a digital programming stream as set forth in greater detail hereinbelow.

More specifically, the content segment 302 may be any system or device which may be utilized to generate and/or provide a program, advertisement, data or other content (hereinafter “content”) in an analog or a digital format to a transmission system. In general, the content segment is responsible for the creation of the content that is to be ultimately provided to the viewer. As such, any type of systems and/or devices may be utilized to create and/or provide content. Examples of content systems and/or devices include: video capturing, recording and/or playback devices, such as video cameras 308 (for example, those capturing a live sporting event), disc arrays 310, such as those found with an advertisement server, optical devices 312 such as DVD players, CD players or the like; magnetic devices 314 such as VHS or other magnetic tape drives; audio capturing recording and/or playback devices, such as radio broadcasts, taped audio files, digital audio files or the like; and/or pre-recorded content, such as, game shows, or late night television, which may be provided via any available medium including, but not limited to, DVDs, CDs, CDROMs, VHS, Beta or other magnetic tapes, laser discs or any other medium. It is to be appreciated that systems, devices and methods for generating content to transmit over a digital transport stream are too numerous to identify herein and any of which may be suitably utilized in conjunction with the various embodiments of the present invention.

Provided any component utilized in the content segment 302 is capable of receiving an MPEG-2 data packet, the various embodiments of the present invention may be configured to provide commands and instructions to any device configured to receive either DVS380 formatted messages and/or MPEG-2 transport streams containing commands that have been inserted into the MPEG-2 transport stream by a splicer or other device configured to receive and process DVS380 formatted messages.

Further, when the content is originally generated in an analog format, the content segment 302 includes those analog to digital encoders needed to compress and/or otherwise convert an analog signal into a digital signal. Systems for converting analog signals into digital signals are also well known in the art. Further, various encoding and/or data compression algorithms and/or standards may be utilized to encode such data including, for example, the MPEG-2 standard. The various embodiments of the present invention are desirably configured to utilize and/or be compatible with the MPEG-2 standard. However, it is to be appreciated that other encoding algorithms, compression schemes and the like may also be utilized. Further, it is to be appreciated that DVS380 compliant messages or the like may be utilized in the future in another context, for example, in conjunction with MPEG-4 formatted signals or in conjunction with other formats. As such, the various embodiments of the present invention are not to be construed as being limited to only an MPEG-2 implementation and may be utilized in other implementations in which it is desirable to provides commands and/or data in a digital transport stream at practically any time.

Referring again to FIG. 3, the various embodiments of the present invention may also be utilized in conjunction with various types of transmission segments 304. The transmission segment 304 commonly includes amplifiers, switches, inserters, multiplexers, controllers, encoders, modulators, hubs, networks, routers, satellite transmission equipment, server and the like necessary to communicate digital programming signals to a plurality of viewers. To provide such digital programming signals, the transmission segment 304 accesses various programming components (singularly or in parallel), such as video data, audio data, and graphics data, from the content segments, and multiplexes and transmits the programming components to the presentation segment 306. It is to be appreciated that while MPEG-2 packets are desirably utilized with the present invention, the programming components may also consist of media objects, as defined under the MPEG-4 standard, that may be created from any video data, audio data, and/or graphics/textual data, for example, by a media object creator. These programming components may include advertisements that are inserted into the programming signal stream using, for example, a DVS380 compliant inserter/splicer.

Referring again to FIG. 3, a digital programming system 300 may also be configured to include together or separately a presentation segment 306. It is anticipated that a programming system 300 includes a presentation segment 306, for example, when a set-top box or application software is provided by a cable system operator or by a direct broadcast satellite system operator. Similarly, a presentation segments 306 may be a separate component, e.g., when the hardware and/or software are provided by sources not directly related to the transmission or providing of any given programming signal. Examples of such sources include TiVO®, which provides a set-top box that is generally compatible with any programming system, but, is also capable of receiving or may be configure to receive commands and/or data in an MPEG-2 packet. Further, it is to be appreciated that the insertion of real-time frame synchronized data, as discussed in greater detail hereinbelow, may be also accomplished by a personal video recorder which, in effect, provides features and functions similar to those provided by splicers and other insertion devices.

The presentation segment 306 is generally that segment which receives at least one or a plurality of programming signal(s) and provides the desired/selected programming signal(s) to the viewer. Further, a basic presentation segment may be configured to provide systems, devices (such as a chip or software instructions controlling a processor), or components which process instructions, commands and/or other information to determine which of a plurality of incoming programming signals (e.g., streams of MPEG-2 private data packets) to present to the viewer at a given time. Also, these more advanced presentation segments may utilize viewer profile information and/or other information in determining which program segments to present to the viewer at any given time. In yet an even more advanced presentation segment, links to additional content (whether provided on-line or off-line) may also be extracted from programming signals and utilized to further customize a given viewing experience. Thus, it is to be appreciated that a presentation segment 306 utilized in conjunction with the various embodiments of the present invention may include any degree of sophistication, but, desirably includes the capability to process commands embedded into an MPEG-2 transport stream.

As such, it is to be appreciated that the presentation segment may be as simple as a digital receiver, ideally one that is MPEG-2 compliant, connected to a monitor, or as complex as a personal computer or similarly equipped device which may be Web enabled and may be capable of obtaining additional information and/or content to present before, in conjunction with, or after a given segment of a programming signal, an advertisement and/or other content.

Further, the presentation segment may be provided via any device that can decode and output digital audio/video signals for presentation to a viewer. The presentation segment may include, for example, a receiver which is connected to a presentation device which presents programming and advertising content to the viewer. Any devices capable of presenting programming and advertising content to viewers may be utilized as the presentation device. Such devices include, but are not limited to, television receivers, home theater systems, audio systems, video monitors, computer workstations, laptop computers, personal data assistants, set top boxes, telephones and telephony devices for the deaf, wireless communication systems (for example, pagers and wireless telephones), video game consoles, virtual reality systems, printers, heads-up displays, tactile or sensory perceptible signal generators (for example, a vibration or motion), and various other devices or combinations of devices. In some embodiments, the presentation segment may include a receiving system and a presentation device which are incorporated into a single device. In short, the presentation segment 306 should not be construed as being limited to utilizing any specific systems, devices, components or combinations thereof.

Further, the presentation segment 306 may also include a user interface device which interfaces with the receiving system and enables the viewer/user to control or interact with the systems and/or presentation device(s) provide in the presentation segment 306. Numerous interface devices may be utilized by a user to identify oneself, select programming signals, input information, and respond to interactive queries. Such interface devices include radio frequency or infrared remote controls, keyboards, scanners (for example, retinal and fingerprint), mice, trackballs, virtual reality sensors, voice recognition systems, voice verification systems, push buttons, touch screens, joy sticks, and other such devices.

The digital programming system 300 also may be configured to incorporate a user profile system 316. As is commonly appreciated, a user profile system 316 may be configured to collect information about each of the viewers/users or groups of users receiving programming from the transmission segment 304. Information in the user profile system 316 can be collected directly from the presentation segment 306 or indirectly from the transmission segment 304. Information collected by the user profile system 316 may include, but is not limited to, demographic information, geographic information, viewing habits, user interface selections or habits (for example, by tracking selections between advertising options by the user via the interface device (user clicks)), and specific user preferences based, for example, upon user selection and responses to interrogatories provided via interactive programming signals. The user profile system 316 can also be used to distribute profile data to viewers/users or groups. This profiling data can be utilized by the presentation device to select appropriate advertisements from a plurality of targeted advertisements. The user profile system 316 can be integrated as part of and/or accessed by the presentation segment 306, the transmission segment 304 and/or the content segment 302. Also, it may be configured as a stand-alone system that interfaces with the rest of the digital programming system 300, or it can be a distributed system residing across the various subsystems of the digital programming system 300. Further, the user profile system 316 may contain and/or have access to algorithms for selecting, aggregating, filtering, messaging, correlating, and reporting statistics on groups of viewers/users.

Additionally, a data storage device 318 may be utilized in the digital programming system 300 for the temporary or permanent storage of video component data, audio component data, graphics component data, media objects, the content provided in the media objects, transmission signals (for example, in decompressed and/or demultiplexed formats), user profile information, operating routines, commands (such as, Trigger Event Commands (“TEC”) or other data provided in DVS380 descriptors, as are described in greater detail hereinbelow), and/or any other information utilized by the digital programming system 300. The data storage device 318 may be provided in conjunction with the presentation segment 306, may be a stand-alone device co-located with the presentation segment 306, may be remotely accessed (for example, via an Internet connection), may be provided with the transmission segment 304, with the user profile system 316, with the content segment 302, or at any other location in the digital programming system 300. The data storage device 318 may also utilize a combination of local and remote storage devices in order to provide the desired features and functions of the digital programming system 300. Various data storage devices 318, algorithms, programs, and systems may be utilized in conjunction with the digital programming system 300. Examples of such data storage devices 318 include, but are not limited to, hard drives, floppy disks, tape drives, and other magnetic storage media, CD ROMS, digital video disks and other optical storage media, memory sticks, file servers and other digital storage media, and including remote databases and local databases.

As further shown in FIG. 3, various communication links 320 and 322 may be utilized to communicate program segments and advertisements from the content segment 302 to the transmission segment 304 and from the transmission segment 304 to the presentation segment 306, respectively.

With respect to the second communications link 320, as is commonly appreciated, a digital programming signal may be communicated to a presentation segment 306 over various communications mediums. Example of such communications mediums include terrestrial broadcast signals, which generally are provided as an electromagnetic signal which is transmitted over a specific range of the electromagnetic spectrum. The range for which such signals are transmitted is generally set by a national or international governing body, such as the U.S. Federal Communications Commission, and may generally be identified as pertaining to television frequencies, radio frequencies, digital wireless frequencies (such as those provided by cellular telecommunication networks), IEEE 802.11b compliant frequency signals, Ricochets signals, microwave frequencies and the like. Other examples of broadcast mediums with which the various embodiments of the present invention may be utilized include stellar communication signals (i.e., signals originating from satellites in space, which are generally provided over UHF, SHF, EHF and other frequency ranges, as established by the International Telecommunications Union). Additionally, wired mediums such as the Internet, telephone networks, local area networks, wide area networks, private networks, public networks, digital cable networks and other wired mediums may be utilized. In short, any communications medium which is capable of communicating digital programming signals, in general, and MPEG-2 data packets, in particular, may be utilized in conjunction with the various embodiments of the present invention to provide communications connectivity between the transmission segment 304 and the presentation segment 302.

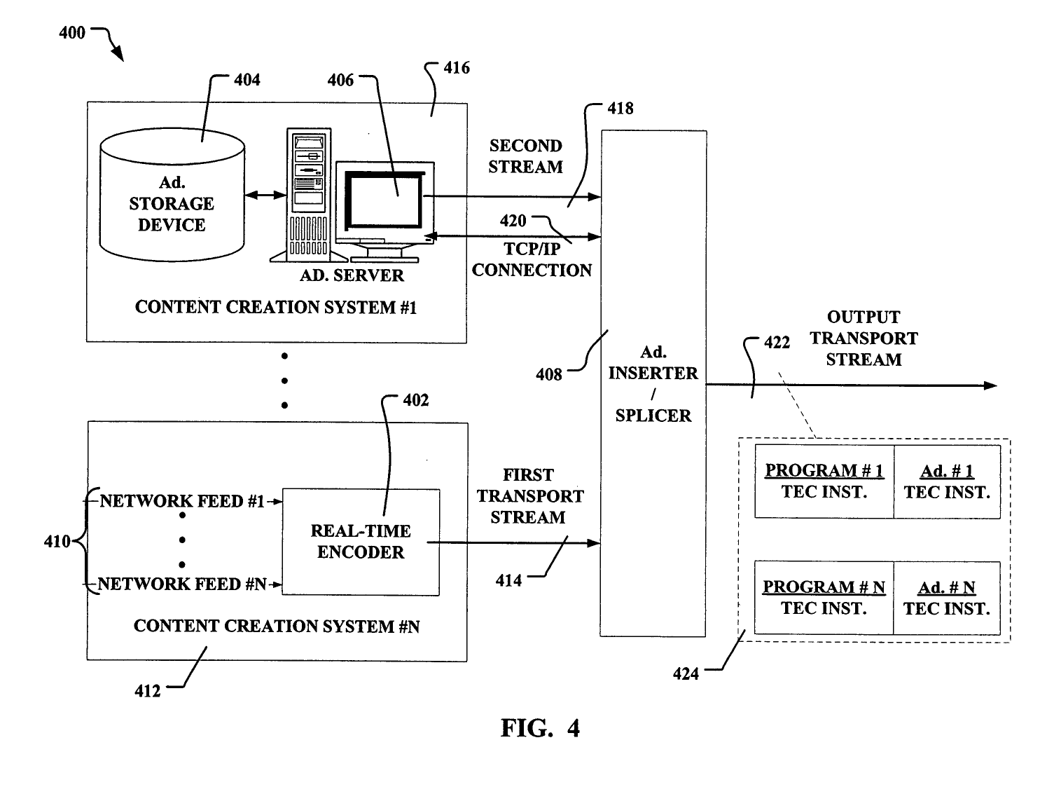

As mentioned above, a first communications link 322 may be provided between the content segment 302 and the transmission segment 304. Referring now to FIG. 4, one embodiment of a segment of devices, which may be utilized in a DVS380 compliant digital programming system, is shown. As shown, a DVS380 compliant system 400 may include a real-time encoder 402, an advertisements data storage device 404, an advertisement server 406 and an advertisement splicer 408. The real-time encoder 402 suitably receives at least one and possibly a plurality of network feeds or other program signals (which are commonly provided in an analog format but may be provided in a digital format) 410. The network feed(s) 410 are then converted, as necessary, using well known in the art processes, into a first transport stream 414 such as an MPEG-2 or other digital transport stream format. The encoder may also be configured to insert DVS253 messages into the first transport stream 414. Depending upon the number of programs desired to be transmitted, one or many transport streams may be outputted from the real-time encoder 402. As shown, the method of receiving a network feed and encoding it into a digital transport stream is depicted as occurring in one of many content systems 412. The output of the content system 412 may then be communicated to at least one advertisement splicer 408, if advertisements are to be inserted into a given programming signal. It is to be appreciated, that even when “commercial free programming” is being provided, it still may be desirable to insert icons for advertisers, links and/or other commands into a digital transport stream. The advertisement splicer 408 suitably accomplishes such insertions.

At least one other content system 416 may also be utilized in this embodiment. As shown, the second content system 416 may be configured to provide advertising and/or other content, in a second stream 418, or an Insertion Multiplex, to the advertisement splicer 408. The second content system 416 generally includes an advertisement storage device 404 in which at least one of a plurality of advertising segments and/or other content may be stored and later retrieved. Ideally, such advertisements and/or other content are stored in a digitally encoded format so that encoding is not required prior to providing any given advertisement to the advertisement splicer 408. However, in other embodiments, the second content system 416 may include analog-to-digital encoders for digitally encoding analog advertisements and/or other content into a digital data signal (e.g., into a plurality of MPEG-2 formatted data packets).

Further, the second content system 416 also includes an advertisement server 406. The advertisement server 406 may be configured to obtain advertisements and/or other content from the advertisement data storage device 404 as indicated by the advertisement splicer 408. The advertisement server 406 is in communication with the advertisement splicer 408, preferably over a TCP/IP configured communications link 420. For at least one embodiment of the present invention, this TCP/IP connections 420 may be established in accordance with the protocols and/or procedures specified in the DVS380 standard.

Generally, one may associate the real-time encoder 402, the advertisements data storage device 404 and the advertisements server 406 as being provided by a plurality of content segments of a digital programming system. Further, one may associate the advertisement inserter/splicer 408 (hereinafter, the “splicer”) as being provided in a transmission segment. However, it is to be appreciated that such associations are arbitrary and such devices may be suitably provided in a digital programming system in, or with, either segment.

The splicer 408 generally outputs at least one output transport stream 422. This output transport stream 422 is suitably modulated, amplified and communicated over a communications link 320 (FIG. 3) to the presentation segment 306. As shown in FIG. 4, any given output transport stream 422 may be configured to transmit a plurality of transport streams 424 at substantially the same time. Each of these transport streams may have advertisements and/or other content inserted into the transport stream at specific times. As discussed previously hereinabove, the DVS253 standard effectively provides “cue-tones” identifying when an advertisement is to be inserted into a given transport stream. The advertisement server 406 and the splicer 408 communicate with each other so that a given advertisement may be inserted into a given first transport stream 414 at a desired time. These communications desirably occur in accordance with the DVS380 standard.

As discussed previously herein, however, the DVS380 standard does not provide a method by which an advertiser may provide frame synchronized commands, such as Triggered Event Commands (“TEC”), into an output transport stream 422 for communication to other system components and/or to the presentation segment 306 (FIG. 3). The various embodiments of the present invention provide for the insertion of commands and/or other data into an output transport stream 422 by delivering digital data to the splicer via DVS380 user-defined descriptors.

More specifically, the DVS380 standard sets forth a format for a splice request message which may be utilized by the various embodiments of the present invention to provide the before mentioned commands and/or other data in the output transport stream 422. One embodiment of a DVS380 splice request message which has been modified to function in accordance with the present invention is shown below in Table 1.

TABLE 1

| Syntax | Bytes | Type |
|---|---|---|
| Splice_Request { | | |
| SessionID | 4 | uimsbf |
| AfterSession | 4 | uimsbf |
| time( ) | | |
| ServiceId | 4 | uimsbf |
| If (ServiceID == 0xFFFFFFFF) | | |
| PcrPID | 2 | uimsbf |
| PIDCount | 4 | uimsbf |
| for (j=0; j<PidCount; j++) | | |
| PIDs( ) | | |
| Duration | 4 | uimsbf |
| EncodedBitrate | 4 | uimsbf |
| SpliceEventID | 4 | uimsbf |
| PostBlack | 4 | uimsbf |
| for (i=0; i<N; i++) | | |
| splice_api_descriptor( ) | | |
| } | | |

As shown in Table 1, the DVS380 splice request message may be suitably modified (by using null values or the like) to include the following fields, when configured to provide commands to a splicer 408 for insertion into an output transport stream 422. These fields normally terminate at the splicer and the values represented above configure the splicer to insert the correct advertisement and/or other content, at the appropriate time, into the output transport stream 422. More specifically, these fields include the following:
SessionID—this field provides an unique identifier for a desired splice event (i.e., the insertion of commands or other data into an output transport stream 422) and may be used to distinguish a given request from any other requests that have been or are going to be issued to a given splicer 408.
AfterSession—this field may be used to specify an advertisement or other MPEG-2 packet after which a programmer desires to insert a command. Further, when it is desirable to insert multiple back-to-back commands into the output transport stream 422, this field may be utilized to the identify the preceding data packet (as identified by its associated SessionID) that the present data packet is to follow. Further, when a given data packet is not following a previously identified packet, this field may be set to the value 0×FFFFFFFF in order to indicate that a time specified in the Time field is to be when the command data packet is desired to be inserted into the output transport stream 422.
time( )—this field specifies the time at which a given command is desired to be inserted into the output transport stream 422. This field is ignored if the AfterSession field is not equal to 0×FFFFFFFF.
ServiceID—this field generally indicates a specific channel providing advertising and/or other content which is to be spliced into the output transport stream 422 in lieu of the first transport stream 414. More specifically, this field provides the program number of the channel or second stream 418 which is desired to be spliced into the output transport stream 422 in place of the first transport stream 414. If this field is set to 0×FFFFFFFF the PIDs and PIDCount are required.
PCR—this field indicates the Program Clock Reference (“PCR”) Packet Identifier (“PID”).
PIDCount—this field indicates the number of PIDs in the second stream 418 (not including the PCR PID unless it is described in the PIDs( ) structure.)
Duration—this field indicates the number of 90 KHz clock ticks the ad server 406 is requesting the splicer 408 to insert.
SpliceEventID—this field is generally set to 0×FFFFFFFF to indicate that a “forced” event/insertion of command data packets into the output transport stream 422 is to be accomplished.
PostBlack—this field is generally set to “0” to indicate that no black video data packets are to be inserted into the output transport stream 422 after any command packets.
splice_api_descriptor( )—this field provides for the addition of at least one descriptor to a DVS380 message.

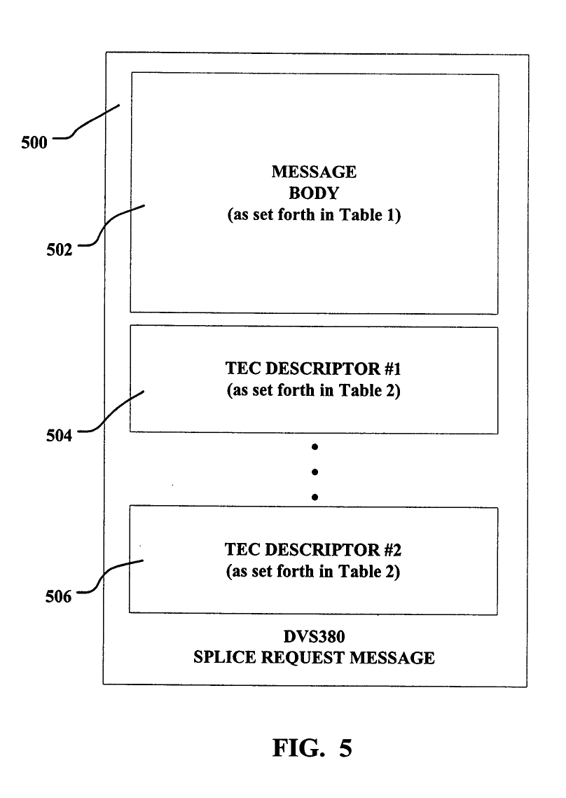

More specifically, the DVS380 standard compliant splice request message 500 format provides for the addition of multiple splice_api_descriptor( ) fields to a message body 502. Any number of these descriptor fields 504/506 may be concatenated to the end of a message body, as shown in FIG. 5. As is commonly appreciated, the DVS380 standard does not provide a format for descriptors that may be utilized to insert commands (for example, commands provided in an MPEG-2 data packet) and/or other data into an output transport stream 422. Instead, the DVS380 standard merely provides for the insertion of playback descriptor and/or muxpriority descriptor messages. As such, it is commonly appreciated that the DVS380 standard merely provides descriptor fields in order to control the operation of the splicer and its interactions with the ad server 406.

In contrast, the various embodiments of the present invention provide for the utilization of the splice descriptor fields to provide command data and/or content, in the format of digitally encoded data packets (for example, MPEG-2 data packets), which may be directly inserted into the output transport stream 422. More specifically, the splice descriptors provided by the present invention may be configured to utilize a format as set forth hereinbelow in Table 2.

TABLE 2

| Syntax | Bytes | Type |
|---|---|---|
| COMMAND_splice_api_descriptor { | | |
| Splice_Descriptor_Tag | 1 | uimsbf |
| Descriptor_Length | 1 | uimsbf |
| Splice_Api_Identifier | 4 | uimsbf |
| COMMAND_Instruction | 246 | uimsbf |
| Delta_Time | 4 | tcimsbf |
| } | | |

As shown in Table 2, a command splice descriptor may be configured to utilize the following fields:

Splice_Descriptor_Tag—this field provides an indication to the splicer 408 of the specific type of descriptor being utilized. This field generally is set as a value from 0×00 to 0×FF to denote the specific descriptor being used. As shown hereinbelow in Table 3, tag values 0×00 to 0×7F are reserved for use by the DVS380 standard, while tag values from 0×80 to 0×FF are vendor unique. For purposes of the present invention, a tag value (for example, of 0×80 or another value, which will be assigned by the SCTE), is preferably utilized to identify the descriptor as providing a command that is associated with a Triggered Event Command (“TEC”) such as one implementing the ACTV® Command Language (“ACL®”). However, it is to be appreciated that any tag value greater than 0×7F may be utilized to identify to a splicer that a command or other content to be directly inserted into an output transport stream 422 is included in the descriptor. Thus, depending upon specific implementations of the various embodiments of the present invention, an implementation thereof may utilize a vendor unique identifier to allow for a larger tag range and a more robust method of adding vendor unique descriptors.

TABLE 3

| Splice_Descriptor_Tag | Definition |
|---|---|
| 0x01-0x7F | Reserved |
| 0x80 | ACTV |
| 0x81-0xFF | Undefined |

Descriptor_Length—this field is configured to provide an eight (8) bit number which provides the length, in bytes, of the command instruction. However, descriptors, in general, are limited by the DVS380 standard to 256 bytes. As set forth below, a command descriptor consistent with the various embodiments of the present invention commonly reserves a minimum of 8 bytes, i.e., one byte for the splice descriptor tag, one byte for the descriptor length (however, the descriptor length field generally does not include the one byte for the splice descriptor tag and one byte for the descriptor length), four bytes for the splice_api identifier field, and four bytes for the delta time. As such, for one embodiment of a command descriptor, the descriptor length field may specify the command instruction length as being a maximum value of 0×F8 or 248 bytes of command data. However, as discussed further below, the delta time, which is a signed number, may be set at any time up to a maximum of 0×7FFFFFFF, or and 0×10000000, or 2147483646 clock ticks after the splice point. However, as the delta time exceeds 300 approximately 300 minutes (or six hours), additional bytes may be eliminated from the command instruction field and utilized in the delta time fields.
Splice_API_Identifier—this field may be configured to provide an identifier of the organization that has defined this descriptor. More specifically, for the present invention, this field is preferably set to an identifier of 0×43554541 (ASCII “CUEA”). However, it is to be appreciated that this field may be set to other identifiers provided the splicer 408, to which such a descriptor is provided, is configured to recognize a customized splice_api_identifier.
Command_Instruction—this field provides a maximum of 248 bytes into which a programmer or others may insert a command for insertion into the output transport stream 422 by a splicer 408. When the output transport stream is providing MPEG-2 encoded programming and/or advertising, preferably, any data entered into this field is provided as an MPEG-2 transport packet containing a four byte header and up to 184 bytes of command instructions (it is to be appreciated, that while 248 bytes are theoretically available, MPEG-2 supports data packets which only have 184 bytes of payload+a four (4) byte header). One example of command and/or other data that may be provided in such a transport packet is a TEC instruction(s). TEC instructions are well known in the art and are not further described herein.
Delta_Time—as briefly discussed hereinabove, this field may be configured to provide a signed double word defining the exact time in PCR clock ticks (or in UTC-Coordinate Universal Time units) that a command, provided in the command instruction field, is to be inserted into the output transport stream 422. This time may be an offset from a given splice time or it may be any desired time. When the time for insertion does not fall within a splice time, the splicer 408 suitably monitors the output transport stream 422 for null or other packets into which such commands may be inserted without impacting the audio, video or other data being then provided in the output transport stream 422. The processes by which such insertions of additional data and/or commands can be made into any given MPEG-2 transport stream are well known in the art. Further, the number entered into this field may vary from 2147483646 clock ticks (23860.93 seconds, or 397.68 minutes) prior to the splice point to 2147483647 clock ticks after the splice point.

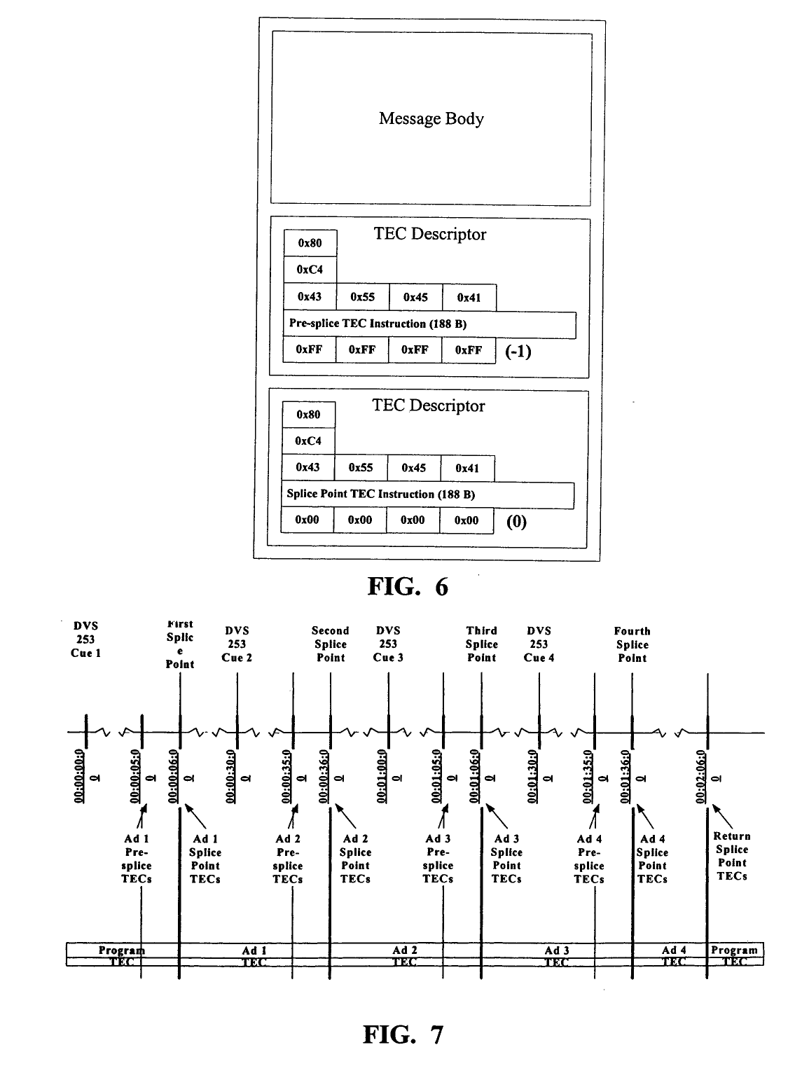

Referring now to FIG. 6, one example of utilizing command descriptors to provide two TEC instructions in an output transport stream via a splice request message is shown. More specifically, this example corresponds to the timing diagram shown in FIG. 7. Desirably, the splicer 408 may insert the TEC commands as close to the delta time as possible. If the splicer 408 cannot insert the TEC command packet(s) at the exact delta time, the splicer 408 will insert the command packets at the next available slot as mentioned previously hereinabove. However, the splicer 408 desirably inserts the TEC packet within the time it takes to transmit one frame of video in the output transport stream 422.

More specifically, FIG. 7 provides one example illustrating the timing of two TEC command instructions with respect to splice points in an interval in which many advertisements provided by at least one second stream 418 are consecutively spliced with at least one first transport stream 414 into an output transport stream 422. In this example, some TEC commands may be spliced into the first transport stream 414 before the splice point and others are spliced at the splice point. These instructions can be interpreted by the set-top box, and/or any component which receives the output transport stream 422. As such, these commands may be provided to any component in the content segment 302, the transmission segment 304 and/or the presentation segment 306. Further, these commands or other commands may be provided in order to set up an operation to be performed when a given advertisement, content or other programming signal is to be presented to a viewer. In other embodiments, these splice point TECs and/or other TECs may be used as triggers to perform an operation at the exact time that an advertisement, a portion of a program being provided in the first transport stream and/or any other content or event occurs or is presented to a viewer. Similarly, using these command descriptors, a digital programming system may be configured to implement manipulate, store, modify, delete, add, insert, and/or otherwise utilize any data or commands provided in a command instruction and preferably on a frame accurate basis.

Further, FIG. 7 illustrates the relative timing of the splice points and TEC Instructions within an advertisement break containing four, thirty (30) second advertisements. As shown, SMPTE (Society of Motion Picture and Television Engineers) time code values may also be chosen and utilized to represent a six second pre-roll time associated with the reception of a DVS253 cue message. Additionally, the TEC instructions in this example may be sent on one-second boundaries and/or at frame boundaries.

Further, it is to be appreciated that for certain embodiments of the present invention the absolute timing of all TEC instructions may be critical to the proper behavior of a given presentation segment device and/or application (for example, a set-top box application). One example of a time critical TEC instruction is one that initiates a splice in a set-top box at the beginning of the advertisement. This splice must be video frame accurate. One example of a non time critical TEC instruction would be a configuration command to a set-top box. Further, it should be recognized that the typical behavior of a splicer may include the “restamping” of timing information including, but not limited to, the Presentation Time Stamp (“PTS”), PCR, and the splice_time( ). In addition, situations may occur where an indicated splice_time( ) may not coincide with an actual access unit or sequence header. In such situations, the splicer may be configured to offset the actual splice_time( ), or other field(s), so as to align the actual splice event with a given boundary. These offsets may occur as often as is necessary for a given implementation of an embodiment of the present invention. In the case where the splice_time( ) is offset, the delta time desirably is calculated with respect to the adjusted splice_time( ). Further, for certain other embodiments, it may be important that the Delta_Time field for a given Command Descriptor is interpreted as the offset from a desired actual splice event, irrespective of any change to the splice_time( ) or other fields.

As discussed previously herein, at least one embodiment of the present invention utilizes splice_api_descriptors concatenated to a splice request message to insert commands into an output transport stream. It is to be appreciated, however, that the DVS380 standard also enables splice_api_descriptors to be concatenated to other request messages communicated between an ad server 406 and a splicer 408. More specifically, Table 4 provides the structure specified in the DVS380 standard for an Init_Request_Data message.

TABLE 4

| Syntax | Bytes | Type |
|---|---|---|
| Init_Request_Data { | | |
| Version ( ) | | |
| ChannelName | 32 | String |
| SplicerName | 32 | String |
| Hardware_Config( ) | | |
| for (I=0; i<N; i++) | | |
| splice_api_descriptor( ) | | |
| } | | |

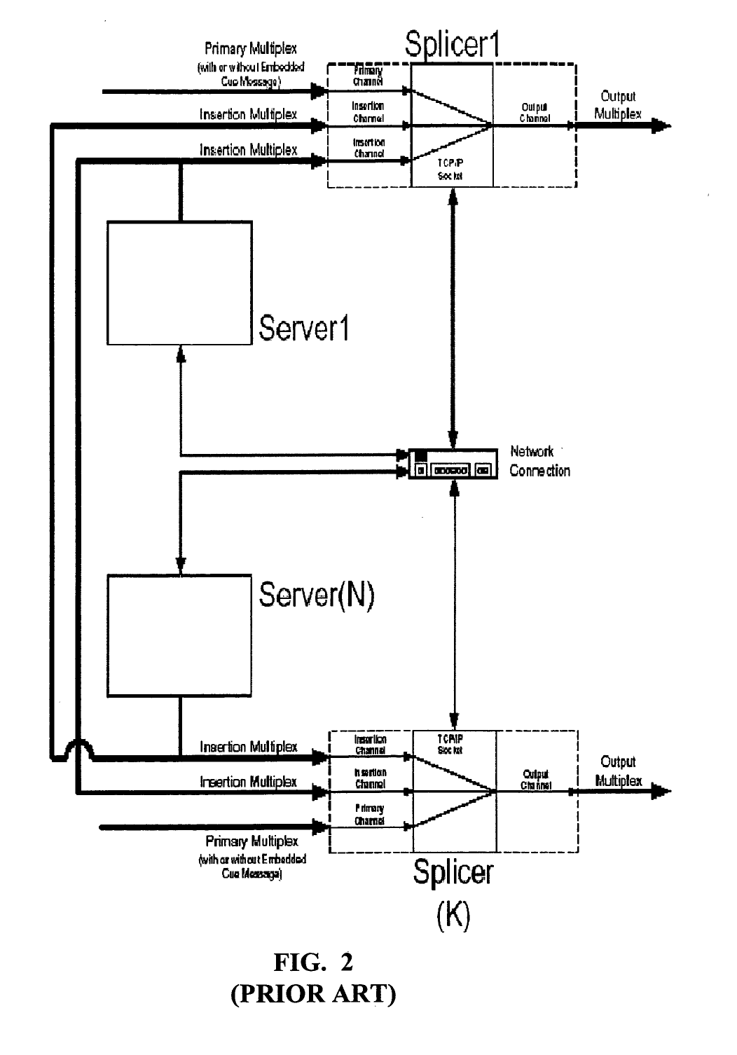

As shown in Table 4, the DVS380 Init_Request_Data message may be suitably modified to also include commands in the splice_api_descriptor field. More specifically, an Init_Request_Data message commonly includes the following fields:
Version—this field provides an identifier of the version of the DVS380 standard that is being utilized by a given ad server 406. Generally, a splicer 408 and an ad server 406 must utilize the same version (or provide support for other versions) to enable communications over a TCP/IP communications link or otherwise to occur.
ChannelName—this field provides an identification of the logical name associated with the first transport stream 414 into which the data commands provided in the splice_api_descriptor field are to be inserted.
SplicerName—this field identifies the name/identity of the splicer to which the commands are to be provided. As shown in FIG. 2, any server may be connected to multiple splicers, this field identifies to which splicer the message is directed.

Hardware_Config( )—this field describes the hardware interface between a server and a splicer. It is important for the splicer to know exactly where the server is connected so that the splicer knows which second stream being referenced. An example of such a link would be an DVB-ASI connection from a server to a splicer.
splice_api_descriptor( )—this field provides for the addition of at least one descriptor to a DVS380 message.

In short, Table 4 illustrates that command instructions may also inserted into in splice_api_descriptor fields set forth in other DVS380 message formats. More specifically, other DVS380 message formats may also be configured to include a splice_api_descriptor field. For example, the “extendeddata_response” message includes a splice_api_descriptor field into which commands may be inserted. Further, other DVS standards may also be configured to include descriptors concatenated to messages. As such, it is to be appreciated that the various embodiments of the present invention may be utilized to concatenate command data packets to any compatible message communicated to a splicer or other component configured to incorporate such command data packets into a transport stream.

Similarly, the beforementioned embodiments of the present invention have been described in the context of an ad server communicating a message to a splicer, wherein the message contains at least one command data packet that is to be inserted into an output transport stream. However, the present invention may also be configured and/or utilized so that command data packets may be inserted into first transport streams, second streams, output transport streams and/or a plurality of transport streams. In short, the present invention may be suitably utilized to provide commands to various other components utilized in a digital programming system so as to insert command data packets into a transport stream. Such other components may include those provided in a content segment, the transmission segment, and/or in the presentation segment. Further, such components may be located along any portion of a transport stream's transmission path. The various embodiments of the present invention could also be utilized in future components utilizing the DVS380 standard. For example, if traffic and billing system adopt the DVS380 standard in the future, the present invention could be used to transmit time critical data from any other device communication to the traffic and billing system over the DVS380 interface.

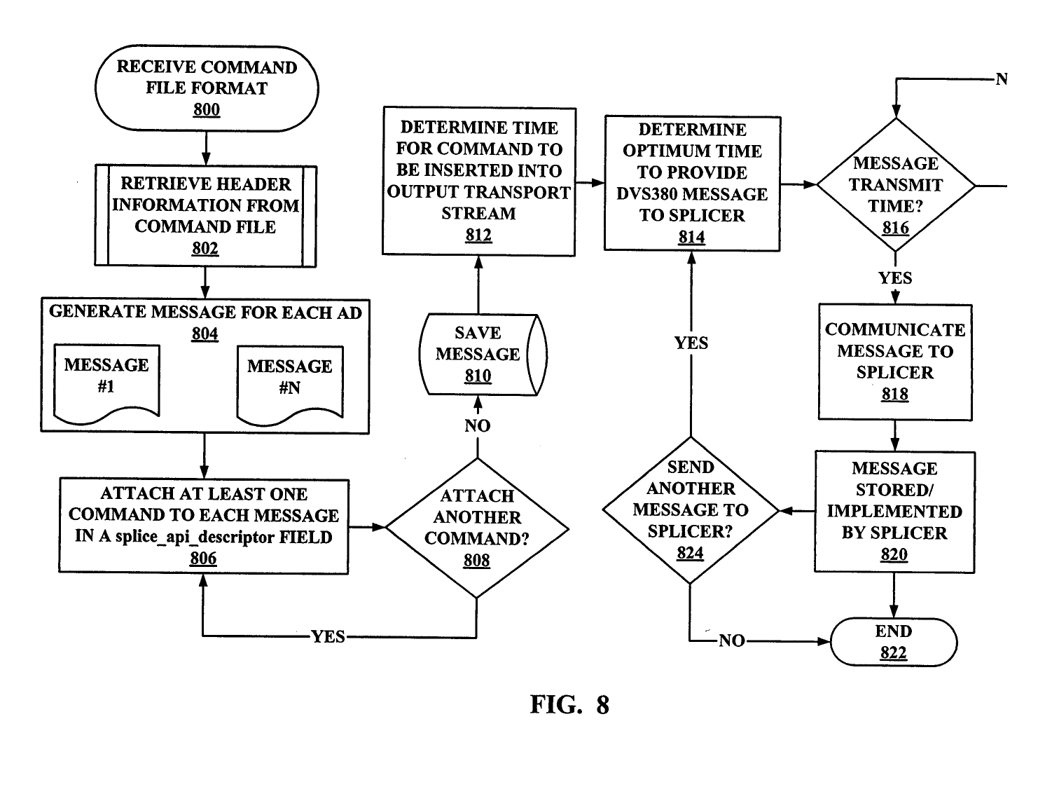

Referring again to FIG. 4, it is anticipated that various embodiments of the present invention may be implemented using TCP/IP or similar network based communication links between an ad server 406 and a splicer 408. Commonly, an ad server 406 does not contain the software and/or hardware needed to generate a command data packet, such as a TEC command packet. As such, the ad server 406 generally is configured to receive command packets from other systems and/or devices, store such command packets, and then insert the command packets into at least one splice_api_descriptor field at the appropriate time. In order to accomplish the generation of a DVS380 message which contains command packets in a splice_api_descriptor field, the ad server needs to receive or generate (when such capability is built into the ad server) data and instructions for creating a DVS380 message. One method by which this may be accomplished is shown in FIG. 8.

As shown in FIG. 8, one embodiment of a method for generating a DVS380 message which includes a splice_api_descriptor field commences with the receipt of a command instruction file format (Operation 800) which provides a header containing a unique identifier that associates the command file with a pre-determined group of advertisements (an Ad Group ID), program segments, or other content (as set forth, for example, by SessionIds) and a count of the total number of descriptors contained in the command file, and the actual descriptors. The method then continues with retrieving the header information from the command file (operation 802) and generating a plurality of DVS380 messages (Operation 804), one for each advertisement identified by the Ad Group ID. It is to be appreciated, however, that one ad group typically represents one targeted advertisement even if it contains multiple audio segments and/or video segments. As such, information associated with a given advertisement may be transmitted to a splicer utilizing one DVS380 message. The DVS380 message may also include many splice_api_descriptors (e.g., TEC descriptors). Ideally, each DVS380 message is substantially the same for each ad so that when a device, such as a set-top box, in the presentation segment receives the commands it merely needs to select one of the ads in the ad group and does not need to process a plurality of commands. More specifically, it is to be appreciated that each header for the plurality of ads may differ only in the ServiceID field, which associates a message with a particular ad.

The method then continues with attaching or concatenating at least one splice_api_descriptor field to the message header (Operation 806) and then determining whether additional commands are to be included with a message header associated with a particular advertisement or other content (Operation 808). If so, then additional messages may be concatenated to the message, as discussed previously hereinabove.

Once all commands, in splice_api_descriptor fields, have been attached to each message, the method continues with saving each message in a data storage device (Operation 810), for example, an ad storage device 404 (FIG. 4) which is accessible by the ad server 406. At this point, the method continues with a calculation of when the command is to be sent to the splicer for insertion into an output transport stream (Operation 812). More specifically, the ad server may be configured to send all associated descriptors when it sends the DVS 380 message to the splicer. In such a situation, the splicer determines when to insert a given command into the output transport stream. Further, for some commands it may be desirable to provide the DVS380 message to the splice 408 many minutes in advance, for other commands, it may be desirable to provide the DVS380 message to the splicer 408 immediately or only a few seconds prior to the desired insertion point. Currently, the DVS380 standard specifies that splice request messages should be sent from the server to the splicer no less than 3 seconds prior to splice_time( ). However, it is to be appreciated that it may be desirable to provide the DVS380 message to the splicer 408 many minutes in advance.

The method continues with determining when to provide the DVS380 message to a given splicer (Operation 814). This determination may be based upon various factors such as whether pre-existing rules or procedures dictate when a message is to be sent to a splicer, whether delays exist in communicating messages over a TCP/IP communications link, and whether time synchronization between the server and splicer is being maintained within thresholds specified by the DVS380 standard. More specifically, the DVS380 standard specifies that time synchronization between ad servers and splicer should be within ±15 milliseconds of each other.

By utilizing internal clocks synchronized to UTC and/or PCR clock references utilized also by the splicer, the ad server may store the message until the appropriate time for sending it arrives. The ad server may also utilize count-down timers, reminders and other techniques for signaling when a message is to be communicated to a splicer. The method suitably provides a waiting period until the message transmit time arrives (Operation 816).

When the message transmit time arrives, the method continues with the ad server and/or any other device capable of generating a DVS380 message, communicating the message to the splicer (Operation 818). At this point, the message is then suitably stored and/or immediately implemented by the splicer (Operations 820) and the method suitably ends (Operation 822).

However, in an alternative embodiment, and as mentioned previously above, a series of messages may be configured to be sent in sequential order to a splicer. For such an embodiment, the method may continue with a determination as to whether additional messages (which relate to the command message) are to be sent to a splicer (Operation 824). Based upon a result of this determination, the method then either ends (Operation 822) or continues with determining the optimum time to provide the next DVS380 message to the splicer (Operation 814). In summary, FIG. 8 provides one embodiment of a method by which an ad server may receive commands (for example, those provided in the TEC format), configure such commands into a DVS380 message format, determine when to send such DVS380 message to a splicer and communicate such message to a splicer. It is to be appreciated that, depending upon specific implementations of the various embodiments of the present invention, this method may vary in flow, operations, information utilized, communication links utilized, systems and/devices utilized and/or in any other way, shape or form.

As discussed above, the ad server may need to be configured with specialized operations, processes, software coding and/or instructions to enable it to attach TEC commands and other commands to DVS380 messages. Similarly, a splicer or any other component which receives a DVS380 message containing a command descriptor may also need to be provided with specialized operations, processes, software coding and/or instructions in order to enable such devices to extract a command from a DVS380 message, store these commands with their appropriate insertion delays and insert the commands at the appropriate time into a transport stream.

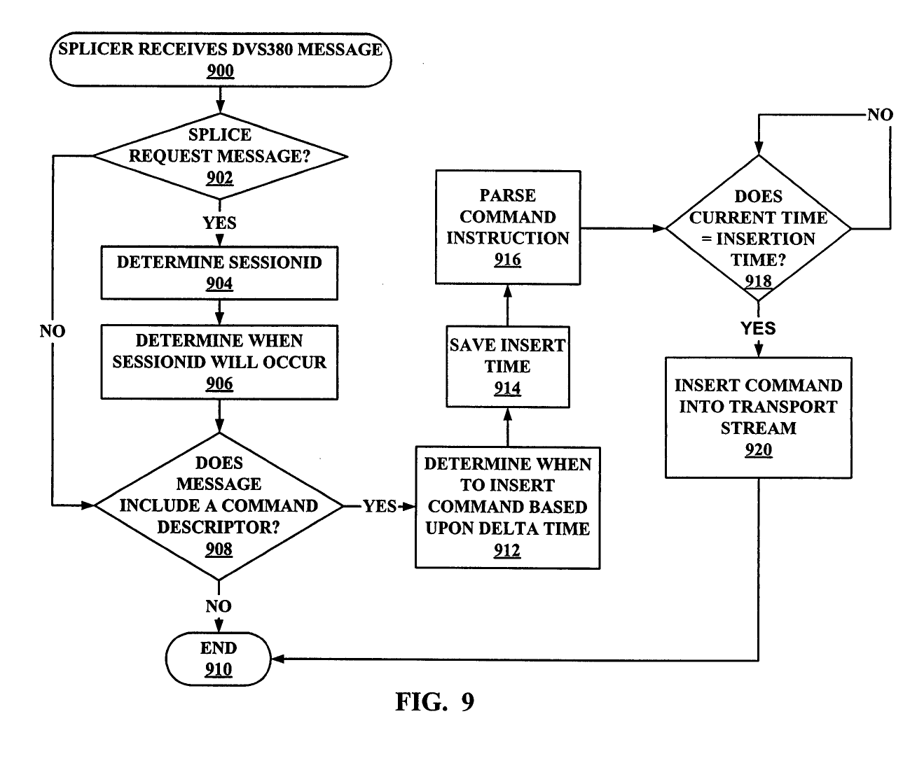

FIG. 9 provides one embodiment of a method for receiving DVS380 messages, extracting commands therefrom, and inserting commands into a transport stream. As shown, this method desirably begins with the splicer (or other device) receiving the DVS380 message (Operation 900). Upon receipt of the message the method continues with a determination of the type of message that is received (Operation 902). When the message is a DVS380 splice request message, the method continues with a determination of which SessionID the splice is to occur (Operation 904) and also a determination is accomplished of when the SessionID will occur based upon the current time (Operation 906). This determination may also include an examination of any priority associated with a given message. The assigning of priorities to messages is fully described in the DVS380 standard.

The method continues with a determination of whether any command descriptors have been attached to the DVS380 splice request message (Operation 908). This determination may be accomplished, for example, by examining the descriptor and determining whether the Splice Descriptor Tag value equals a value assigned to identify the descriptor as a command. For one embodiment, as discussed above, such Tag value is set to the value of 0×80. If none are attached, then for purposes of the present invention, the method effectively terminates (Operation 910).

Further, referring again to Operation 902, when the message is not a splice request message, the method skips the steps of determining when a given SessionID will occur and instead proceeds to the determination provided in Operation 908.

Referring again to Operation 908, when the message includes a command descriptor (regardless of whether the message is a splice request message, an init request data message, or some other message format, the method continues with determining when to insert the command based upon the time specified in the Delta Time field (Operation 912).

More specifically, when the command is being provided in a splice request message, the time at which a given command is to be inserted may be determined by utilizing the time determined in Operation 906 (i.e., when the identified SessionID will occur) and adding the delta time to the SessionID time. As mentioned previously hereinabove, the delta time may be a negative or positive number, wherein a negative number designates an amount of time prior to the SessionID time, or splice_time( ), and a positive number designates an amount of time after the SessionID time, or splice_time( ). The result of this calculation may be designated as the insertion time (i.e., when the command is to be inserted into the output transport stream).

When the command is not being provided in a splice request message or any other message format that specifies a SessionID, the time at which a given time is to be inserted may be determined by utilizing the present UCT and/or PCR (whichever is desired) and adding the delta time to such current time. In this instance, it is to be appreciated that the delta time can not be a negative number, because systems and processes do not currently exist for traveling or proceeding back into time. As such, for non-splice request messages, the delta time indicates a future time at which the command is to be inserted into the output transport stream. This delta time may be “0”—i.e., in order to indicate that the command should be sent as soon as is possible. Once the insert time is determined, it is then suitably “saved” (Operation 914). As used in this context, an insert time may be “saved” by providing an alarm, count-down timer, trigger or any other mechanism or operation for marking when to insert a command into the output transport stream.

The method then continues (either serially or in parallel, for example, when multi-tasking processors are being utilized) with parsing the command instructions provided in the COMMAND_Instruction field (e.g., see Table 2) (Operation 916). Ideally, the parsing of the command instruction occurs immediately (or substantially thereabout) after reception of the DVS380 message by a splicer or similar device. Immediate parsing of the message is desired because it provides greater assurance that all command instructions (such as TEC instructions) will be inserted properly into the output transport stream. More specifically, the command instructions may be parse by storing the 246 (or less) bytes of the command instruction in a data storage device accessible to the splicer (or similar device). Further, for at least one embodiment of the present invention, the splicer does not parse the command itself. Instead, the splicer parses the descriptor, stores the command and delta time fields, then inserts the command at the appropriate time in the output transport stream.

At this point, the method then continues with waiting until the current time equals the previously determined insertion time (Operation 918). When that time occurs, the command is then inserted into the transport stream (Operation 920). At this point the method ends (Operation 910).

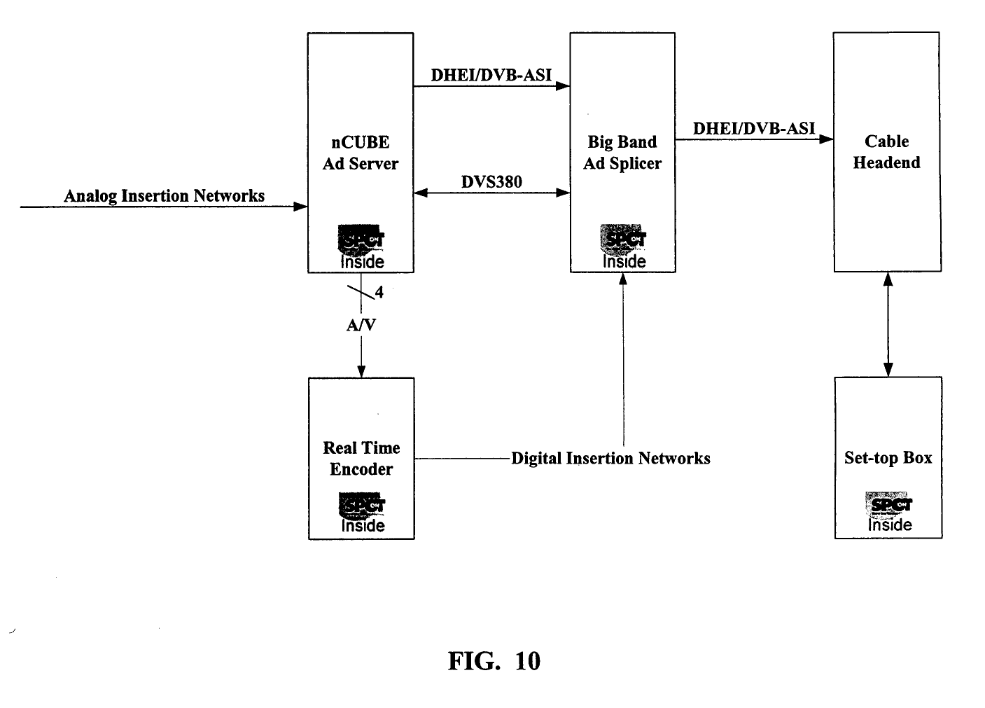

With reference to FIG. 10, one example of an implementation of one embodiment of the present invention is provided. As shown, this embodiment provides for the insertion of non-enhanced advertisements offline, e.g., via an analog nCUBE® advertisement insertion system to an analog version of an insertion network. Such analog insertion can be performed in the manner by which nCUBE currently inserts analog advertisements into cable systems, for example, by using DTMF triggers which are inserted by a switchbox. These output streams are then captured on a DTS stream server for play-out and DPI program insertion at air time.

Further, for the embodiment shown in FIG. 10, digital networks with DVS253 messaging and analog insertion may be captured and stored on a DSTS Stream Server. At air time, the stream may be played out to an ad splicer (for example, one provided by BigBand®). Upon detection of a DVS253 message, the splicer communicates with the ad server over a DVS380 interface and prepares the pre-muxed single-file advertisements for digital insertion. It is to be appreciated that the embodiment shown in FIG. 10 may also be modified to include an ad server which provides an advertisement to a real-time encoder connected to the splicer. At insertion time, the splicer then switches in the multiple-ad multiplex. The splicer also insert appropriate targeting information by way of ACTV Command Language (“ACL”) commands delivered over the DVS380 interface using a TEC protocol, in accordance with at least one of the above described embodiments of the present invention. In this manner, the system shown in FIG. 10 provides a fully digital head-end using DPI program insertion. In other embodiments, a similar system may include a combined analog/digital insertion system or a fully digital insertion system, depending on the specific head-end requirements, and the availability of any necessary equipment.

Further, targeting advertising may be accomplished via the various embodiments of the present invention by installing small ACL client applications in set-top boxes and/or other presentation segment devices. In such a configuration, when an appropriate ACL command is received by the presentation segment in a transport stream, the ACL instructs the presentation segment device to switch a transport demultiplexer to a different PID, which identifies a different group of pictures (when used in an MPEG-2 embodiment). Further, by using seamless switching technologies, such as those developed by ACTV®, and described in U.S. Pat. No. 6,181,334, the entire contents of which are incorporated herein by reference, seamless switching between transport streams may be accomplished in a fully digital programming and advertising system which is implemented in accordance with at least one embodiment of the present invention. Such seamless switching could be accomplished, for example, by utilizing a receiving device which has two tuners, two demodulators and a transport integrated circuit with two locked transports stream inputs. Other embodiments might also be utilized, as desired, to provide seamless switching between multiple transport streams.

While the various embodiments of the present invention have been described in the context of various system and method embodiments, it is to be appreciated that the present invention is not to be construed as being limited to any particular communication mediums, data transfer formats, protocols, standards, devices, equipment, systems, configurations, processes, command structures or the like. For example, an alternative embodiment may utilize practically any communications medium via which digital data may be transmitted including those provided over coax cables, Ethernet cables, fiber-optic cables and the like.

1. A system for inserting commands into a digital programming signal comprising:
a digital ad server which generates at least one message having an attached command; and
a digital splicer which receives the message from the ad server, extracts the attached command and splices the command into a digital transport stream.

2. The system of claim 1, wherein the message further comprises a message which is in a DVS380 compliant format.

3. The system of claim 2, wherein the DVS380 compliant message includes at least one descriptor.

4. The system of claim 3, wherein the DVS380 message further comprises a DVS380 splice request message.

5. The system of claim 4, wherein the descriptor includes at least one field for inserting a command instruction.

6. The system of claim 5, wherein the descriptor includes at least one field for specifying a time difference from a reference time at which to insert the command into a digital transport stream.

7. The system of claim 1, wherein the digital ad server generates at least one message having more than one commands.

8. The system of claim 1, wherein the message further comprises a delta time indication from a pre-determined reference and the digital splicer splices the command into a digital transport stream based upon a calculation of the delta time with the reference and the current time.

9. The system of claim 1, wherein the command is spliced into the digital transport stream on a frame accurate basis.

10. The system of claim 1, wherein the message is in the DVS380 standardized message format and the command is provided in a descriptor field.
